(19) United States
(12) Patent Application Publication
(10) Pub. No.: US 2025/0227491 A1
(43) Pub. Date: Jul. 10, 2025

(54) Methods and Network Node for Beam Management in a Wireless Communication Network

(71) Applicant: Telefonaktiebolaget LM Ericsson (publ), Stockholm (SE)

(72) Inventors: Bo Göransson, Sollentuna (SE); Jing Rao, Sollentuna (SE)

(21) Appl. No.: 18/853,776

(22) PCT Filed: Apr. 13, 2022
(86) PCT No.: PCT/SE2022/050372

§ 371 Date: Oct. 3, 2024

(51) Int. Cl. H04W 16/28; H01Q 21/00; H04B 7/06

(52) U.S. Cl. CPC H04W 16/28; H01Q 21/00; H04B 7/06952

(57) ABSTRACT

A method performed by a network node (130) of a wireless communication network (100) for beam management is provided. The network node (130) controls a Phased Array Antenna Module, PAAM (202), capable of beamforming for directed communications with a user equipment, UE (140). The method comprises: communicating (304) signals with the UE (140) over a serving beam (402) in a first beam pattern, the first beam pattern being formed by a first set of antenna elements of the PAAM (202); selecting (306) a number of measurement beams (404) in the first beam pattern; obtaining (308) a measurement of signal quality in each of the selected (306) number of measurement beams (404); selecting (310) a candidate beam (406), the candidate beam being a beam from a second beam pattern, formed by a second set of antenna elements of the PAAM (202), different from the first set of antenna elements, based on the individual measurements of signal quality of each of the number of measurement beams (404), the first beam pattern and the second beam; communicating (312) signals with the UE (140) over the selected (310) candidate beam (406) after switching to the second set of antenna elements.

### TECHNICAL FIELD

The present disclosure relates generally to methods and network node for beam management in a wireless communication network. The present disclosure also relates to computer programs and carriers corresponding to the above methods and network node.

### BACKGROUND

To meet the huge demand for higher bandwidth, higher data rates and higher network capacity, due to e.g. data centric applications, existing 4^{th} Generation (4G) wireless communication network technology, aka Long Term Evolution (LTE) is being extended or enhanced into a 5^{th} Generation (5G) technology, also called New Radio (NR) access. The following are requirements for 5G wireless communication networks:
Data rates of several tens of megabits per second should be supported for tens of thousands of users;
1 Gigabit per second is to be offered simultaneously to tens of workers on the same office floor;
Several hundreds of thousands of simultaneous connections is to be supported for massive sensor deployments;
Spectral efficiency should be significantly enhanced compared to 4G;
Coverage should be improved;
Signaling efficiency should be enhanced; and
Latency should be reduced significantly compared to 4G.

Multiple Input Multiple Output (MIMO) is a method for multiplying the data carrying capacity of a radio link using multiple transmission and receiving antenna elements at a network node and possibly also at the wireless device to exploit multipath propagation. The MIMO technology includes Single User MIMO (SU-MIMO) and Multi-User MIMO (MU-MIMO). SU-MIMO allows only a pair of wireless devices to simultaneously send or receive multiple data streams, while MU-MIMO allows a single access point to simultaneously communicate with multiple devices to improve overall efficiency.

In MIMO techniques, the multiple antenna elements are used for beamforming wireless signals to be transmitted and received. Beamforming means focusing the sent signals in different directions, for a network node especially in a direction of a wireless device with which the network node communicates. Hereby, transmission capacity of the network node is saved.

There are time-domain and frequency-domain beamforming, as well as digital and analog beamforming. In time-domain analog beamforming, the same signal is distributed in time-domain into at least a part of all antenna elements of a network node. By only adjusting the phase of the signal at the individual antenna elements, a single “pencil beam”, i.e., a narrow, sharp beam with a rather high gain can be created by the antenna array or maybe a plurality of antenna elements. The resulting wirelessly transmitted signal which is resulting from the simultaneous transmission of signals from the individual antenna elements, will therefore be received with higher amplitude at the receiving end.

Current 5G NR millimeter Wave (mmWave) products are implemented using a so-called Phased Array Antenna Module (PAAM) which contain analog radio frequency (RF) beamformers to generate high-gain beams. A PAAM is an array antenna whose single radiators can be fed with different phase shifts.

FIG. 1 shows a typical PAAM 202. The PAAM 202 contains a dual-polarized array of antenna elements fed by a number of RF beamforming circuits (RFICs), each antenna element of the array being marked as a square in the FIG. 1. The PAAM 202 can generate one beam 204 per polarization over the supported bandwidth. In the scenario shown in FIG. 1, this dual-polarized beam 204 is used to serve one wireless device with two layers of data, which is SU-MIMO.

If several wireless devices are located closely and report the same “best” beam, several wireless devices can be frequency multiplexed on the same beam. To serve two or more wireless devices that prefer different beams, i.e., in different directions, several separate beams are needed. One way to achieve this is to split the PAAM into several sections, where each section is serving one wireless device using the same time-frequency resource, i.e., MU-MIMO, where each wireless device can use two layers. One example of such a PAAM-split used to generate four layers is shown in FIG. 2. In this case the PAAM 202 of FIG. 1 is split in two segments 210 and 212. The PAAM 202 can now generate one beam 214 per polarization over the supported bandwidth from the first segment 210 and another beam 216 per polarization from the second segment 212.

To serve more wireless devices, the PAAM can be split into more segments, vertically or horizontally or both. Apart from the split shown in FIG. 2, two other possible splits are shown in FIG. 3a and FIG. 3b. In FIG. 3a, the PAAM panel of FIG. 1 is split into three segments 218, 220 and 222. In FIG. 3b the PAAM panel of FIG. 1 is split into four segments 224, 226, 228 and 230. These are just examples and the PAAM panel can be split in other ways.

One drawback with splitting the PAAM is the loss in equivalent isotropic radiated power (EIRP) and equivalent isotropic sensitivity (EIS). If the PAAM is split into two segments, each segment only covers half the array and hence the generated beam gain is reduced by 3 dB. Also, since only half of the power amplifier resource is available in each segment, the transmitted power will be 3 dB less per PAAM segment. This means that when the PAAM is split into two parts, the downlink beam will have 6 dB lower EIRP, while the EIS will be reduced 3 dB by the lower beam gain. Correspondingly, if the panel is split into four segments, the EIRP will be reduced by 12 dB while the EIS is 6 dB compared to using the full PAAM to generate the beams.

When several wireless devices are in positions with very good channel conditions, it would be possible to schedule two or more of the wireless devices at the same time with good enough quality from a split PAAM, that is MU-MIMO. So, such a situation may occur: in a first time slot only one wireless device can be served from a full PAAM and SU-MIMO is supported, in a second time slot two or more wireless devices can be served from a split PAAM and MU-MIMO is supported. Another alternative situation is: in a first time slot two or more wireless devices can be served from a split PAAM, in a second time slot only one wireless device can be served from a full PAAM. A further alternative situation is: in a first time slot one wireless device can be served from a segment or a split PAAM, in a second time slot the wireless device can be served from another segment or a split PAAM, the two segments of PAAM differ from each other. In order to efficiently support the above mentioned situations, there is a need to do such a PAAM configuration switching dynamically, from e.g. a full PAAM to a split PAAM or vice versa, or one segment of PAAM to another segment of PAAM, depending on the current traffic situation in the cell.

When switching from one PAAM configuration to another PAAM configuration dynamically, one consequence of changing the effective array size of the PAAM panel is that the gain and width of the generated beams will change dynamically. For example, when splitting the full PAAM panel in two halves, the beamwidth from each half PAAM will be doubled in the dimension where the split occurs. This will then impact the beam management for the wireless devices. For example, assuming the SU-MIMIO is used, and a single wireless device is served by the full panel with beam bₖ, then in the next slot after splitting the PAAM, the same wireless device is still served, but now it is to be served together with an added additional wireless device, so that MU-MIMO is utilized. Thus, the PAAM panel is split into two halves dynamically to be able to generate two simultaneous beams. Specifically, the full PAAM is split into a first and a second segment, each segment being one half of the PAAM. The first segment will be used by the first wireless device and the second segment will be used by the second wireless device. However, since the antenna array size of the segments are different from the antenna array size of the full PAAM, the original beam bₖ of the full PAAM panel cannot be used after splitting. Instead, two new beams generated respectively from the two smaller antenna arrays must be used. In another situation, one segment of the PAAM is used before switching and the full PAAM is used after switching. In another situation, one segment of the PAAM is used before switching and another segment of the PAAM is used after switching.

Hence, in order to serve wireless devices reliably, it is important to be able to perform such PAAM configuration switching in a reliable way. Also, there is a need to find a suitable serving beam for a particular wireless device after a PAAM configuration switching. The found serving beam should be a high-performance beam which can serve the particular wireless device stably.

### SUMMARY

It is an object of the invention to address at least some of the problems and issues outlined above. It is possible to achieve these objects and others by using methods, and network nodes as defined in the attached independent claims. It is an object of embodiments of the invention to perform PAAM configuration switching reliably, quickly and dynamically. It is an object of embodiments of the invention to find a suitable serving beam for a particular wireless device after a PAAM configuration switching from using a first set of antenna elements to a second set of antenna elements. It is an object of embodiments of the invention to achieve a beam management that efficiently serves wireless devices after PAAM configuration switching. It is possible to achieve one or more of these objects and possibly others by using methods and network nodes as defined in the attached independent claims.

According to one aspect, a method performed by a network node of a wireless communication network for beam management is provided. The network node controls a Phased Array Antenna Module, PAAM, whereby the network node is capable of forming beams for directed communication of wireless signals with a number of user equipment, UE. The method comprises communicating signals with a UE over a serving beam formed by a first set of antenna elements of the PAAM, the first set of antenna elements forming a first beam pattern in a beam direction space, the serving beam being one beam in the first beam pattern. The method further comprises selecting a number of measurement beams in the first beam pattern, the number of measurement beams being neighbours to the serving beam. The method further comprises obtaining a measurement of signal quality in each of the selected number of measurement beams. The method further comprises selecting a candidate beam based on the individual measurements of signal quality of each of the number of measurement beams, the first beam pattern and the second beam pattern, the second beam pattern being formed by a second set of antenna elements of the PAAM, the first set of antenna elements differs from the second set of antenna elements, the selected candidate beam being one beam in the second beam pattern. The method further comprises communicating signals with the UE or other UE over the selected candidate beam after switching to the second set of antenna elements.

According to another aspect, a network node is provided. The network node is configured to operate in a wireless communication network and configured for controlling a Phased Array Antenna Module, PAAM, whereby the network node is capable of forming beams for directed communication of wireless signals with a number of user equipment, UE. The network node comprises a processing circuitry and a memory, said memory containing instructions executable by said processing circuitry. The network node is operative for communicating signals with a UE over a serving beam formed by a first set of antenna elements of the PAAM, the first set of antenna elements forming a first beam pattern in a beam direction space, the serving beam being one beam in the first beam pattern. The network node is further operative for selecting a number of measurement beams in the first beam pattern, the number of measurement beams being neighbours to the serving beam and obtaining a measurement of signal quality in each of the selected number of measurement beams. The network node is further operative for selecting a candidate beam based on the individual measurements of signal quality of each of the number of measurement beams, the first beam pattern and the second beam pattern, the second beam pattern being formed by a second set of antenna elements of the PAAM, the first set of antenna elements differs from the second set of antenna elements, the selected candidate beam being one beam in the second beam pattern. The network node is further operative for communicating signals with the UE or other UE over the selected candidate beam after switching to the second set of antenna elements.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is schematic block diagrams of PAAM panel.

FIG. 2 is schematic block diagrams of split PAAM panel.

FIG. 3a and FIG. 3b are schematic block diagrams of different ways of splitting PAAM panel.

FIG. 4 is a schematic block diagram of a wireless communication network in which the embodiments of the present invention may be used.

FIG. 5 is a flow chart illustrating a method performed by a network node, according to possible embodiments.

FIGS. 6a and 6b comprise two diagrams of beam patterns in azimuth and elevation space.

FIG. 7a-7d are schematic diagrams of the selection of the candidate beam according to possible embodiments.

FIG. 8a-8d are schematic diagrams of the selection of the candidate beam according to other possible embodiments.

FIG. 9 is a schematic diagram of the selection of the candidate beam according to another possible embodiment.

FIG. 10 is a schematic diagram of beam establishment, refinement and tracking procedure between a gNodeB and a UE.

FIG. 11 is a flow chart illustrating a process of beam establishment, beam refinement and beam tracking.

FIG. 12 is a block diagram illustrating a network node in more detail, according to further possible embodiments.

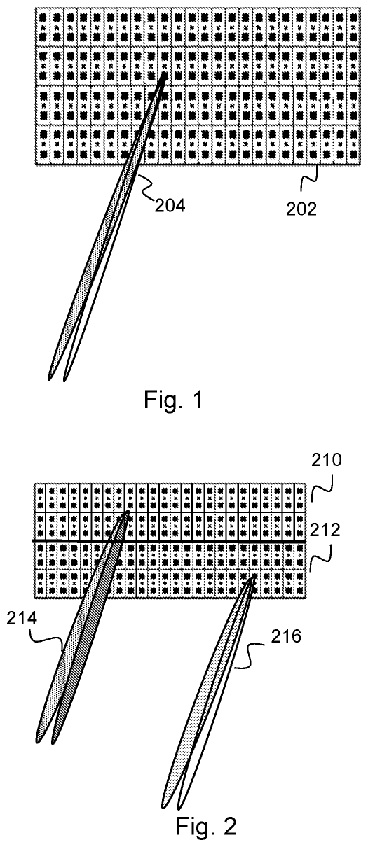

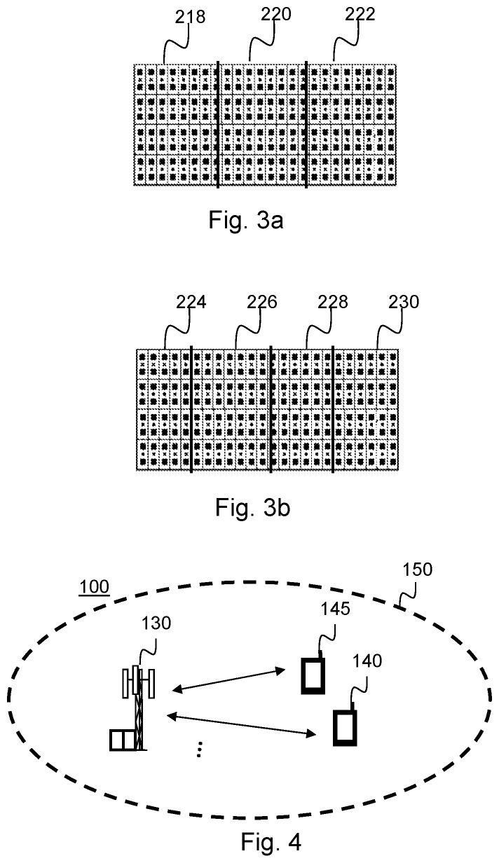

### DETAILED DESCRIPTION

FIG. 4 shows a wireless communication network 100 comprising a network node 130 that is in, or is adapted for, wireless communication with a number of wireless devices 140, 145. The network node 130 provides radio coverage in a cell 150, which is a geographical area. The number of wireless devices 140, 145 resides in the cell 150.

The wireless communication network 100 may be any kind of wireless communication network that can provide radio access to wireless communication devices. Example of such wireless communication networks are Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE) Frequency Division Duplex (FDD) and Time Division Duplex (TDD), LTE Advanced, Wireless Local Area Networks (WLAN), Worldwide Interoperability for Microwave Access (WiMAX), WiMAX Advanced, as well as 5G wireless communication networks based on technology such as New Radio (NR). However, the embodiments of the following detailed description are described for NR.

The network node 130 may be any kind of network node that provides wireless access to the number of wireless devices 140, 145 alone or in combination with another network node. The network node 130 may also be called radio network node or simply network node in this disclosure. Examples of network nodes 130 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a remote radio unit (RRU), a remote radio head (RRH), nodes in a distributed antenna system (DAS) and a multi-standard radio BS (MSR BS).

The number of wireless devices 140, 145 may be any type of device capable of wirelessly communicating with a radio access network node 130 using radio signals. The number of wireless devices may also be called User Equipment (UE) in this disclosure. For example, the number of wireless devices 140, 145 may be a UE, a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

The embodiments described may be applicable to single carrier as well as to multicarrier (MC) or carrier aggregation (CA) operation of the number of wireless devices. The term carrier aggregation (CA) may also be called multi-carrier system, multi-cell operation, multi-carrier operation, and multi-carrier transmission and/or reception. The embodiments may equally apply for Multi radio bearers (RAB) on some carriers, which means that data and speech are simultaneously scheduled.

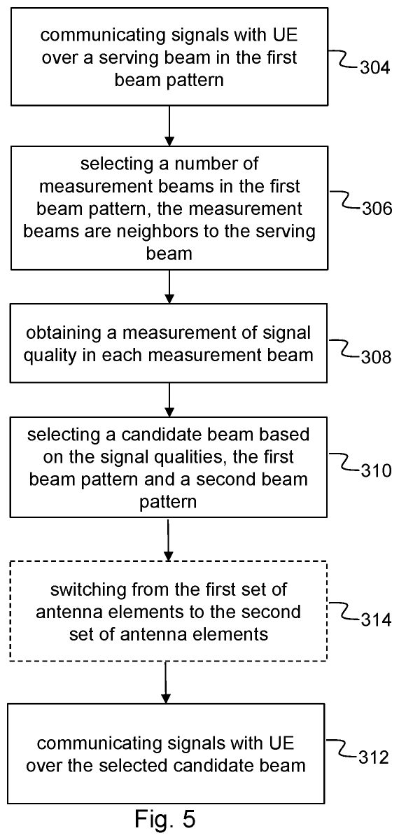

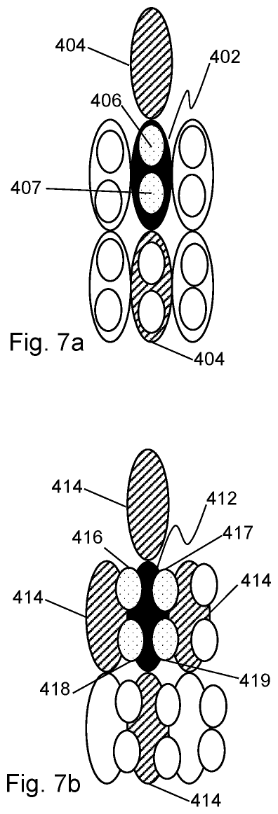

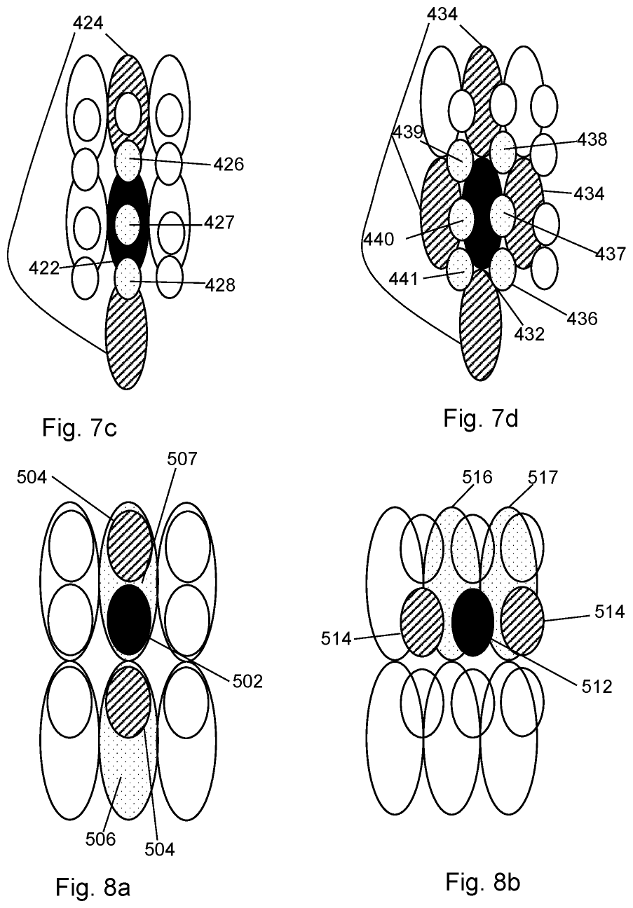

FIG. 5, in conjunction with FIG. 4, describes a method performed by a network node 130 of a wireless communication network 100 for beam management. In order to better illustrate the invention, the method is also shown in conjunction with FIG. 7a that shows one embodiment of selection of candidate beam for one arrangement of first and second beam pattern. However, the method is also applicable to other embodiments of candidate beam selection, such as the ones shown in FIGS. 7b-7d, 8a-8d and 9. The network node 130 controls a Phased Array Antenna Module, PAAM 202, whereby the network node 130 is capable of forming beams for directed communication of wireless signals with a user equipment, UE 140. The method comprises communicating 304 signals with the UE 140 over a serving beam 402 formed by a first set of antenna elements of the PAAM 202, the first set of antenna elements forming a first beam pattern in a beam direction space, the serving beam being one beam in the first beam pattern. The method further comprises selecting 306 a number of measurement beams 404 in the first beam pattern, the number of measurement beams being neighbours to the serving beam. The method further comprises obtaining 308 a measurement of signal quality in each of the selected 306 number of measurement beams 404. The method further comprises selecting 310 a candidate beam 406 based on the individual measurements of signal quality of each of the number of measurement beams 404, the first beam pattern and a second beam pattern, the second beam pattern being formed by a second set of antenna elements of the PAAM 202, the first set of antenna elements differs from the second set of antenna elements, the selected 310 candidate beam 406 being one beam in the second beam pattern. The method further comprises communicating 312 signals with the UE 140 or other UE 145 over the selected 310 candidate beam 406 after switching to the second set of antenna elements.

The PAAM 202 controlled by the network node 130 can be comprised in the network node 130, or can be implemented in a cloud, while the network node 130 controls the PAAM 202 in the cloud remotely.

In the step of communicating 304, the beam direction space refers to a space defined with azimuth angles and elevation angles as defined from the network node 130, i.e., with the network node 130 in the origin of a coordinate system. This definition of beam direction space applies to all the embodiments in this invention.

In the step of selecting 306, the selected number of measurement beams 404 are neighbours to the serving beam 402. The term “neighbours” refers to that the selected number of measurement beams are adjacent to the serving beam 402. According to an embodiment, the term “adjacent” means that there is no other beam of this beam pattern in between the selected measurement beam and the serving beam 402. According to another embodiment, “adjacent” means two beams are within a certain angular distance from one another in the beam direction space. The angular distance can be defined by the center positions of the beams. The certain angular distance can be predefined or calculated. Beam width can be taken into account when calculating the angular distance. Wide beams may be considered adjacent at a greater angular distance than narrow beams. The second definition of “adjacent”, i.e. that two beams are adjacent when the two beams are within a certain angular distance from one another in the beam direction space, is also applicable when deciding if the candidate beam is adjacent to the serving beam even if they are in different beam patterns.

In some embodiments, the selected measurement beams 404 are all the adjacent beams to the serving beam 402. In another embodiment, the selected number of measurement beams 404 are part of the adjacent beams to the serving beam 402. The serving beam 402 is by default having the best signal quality. By selecting the number of measurement beams 404 which are neighbours to the serving beam 402, the selected number of measurement beams 404 are actually those beams which may also have good enough signal quality.

In the step of selecting 306, the selection can be performed in response to a determination to switch from the first set of antenna elements of the PAAM 202 to a second set of antenna elements of the PAAM for communication with the UE 140. The selection can also be performed for a possible upcoming determination to switch from the first set of antenna elements to the second set of antenna elements. The selection can further be done when beam tracking is performed.

In the step 308, the obtained signal quality can be any signal quality indicator, e.g., reference signal received power (RSRP), channel quality indicator (CQI), received signal strength indicator (RSSI), channel state information (CSI), etc.

In the step of selecting 310, the first set of antenna elements differs from the second set of antenna elements. The first set of antenna elements and the second antenna elements can be totally different, e.g., as the 210 and 212 in FIG. 2. The first set of antenna elements and the second antenna elements can also partially overlap with each other, e.g., the first set of antenna elements are antenna elements of the whole PAAM and second set of antenna elements are the antenna elements in the segment 212 in FIG. 2, or vice versa, the first set of antenna elements are antenna elements of PAAM segment 212 in FIG. 2 and second set of antenna elements are the antenna elements in the whole PAAM. However, the first set of antenna elements does not totally overlap with the second set of antenna elements.

In the step of communicating 312, the selected 310 candidate beam 406 is used as a new serving beam after switching from the first set of antenna elements to the second set of antenna elements. The UE being served can be the same UE 140, or other UE 145 or UEs.

By such a method, a proper candidate beam of the second set of antenna elements is found considering the signal quality. A limited number of measurement beams are selected thus a limited number of signal qualities are obtained. An unambiguous selection of the most proper beam in the second set of antenna elements is performed and the communication quality can be guaranteed after switching to the second set of antenna elements.

According to an embodiments, the candidate beam 406 is selected 310 based on the individual measurements of signal quality of each of the number of measurement beams 404, a position in the first beam pattern in the beam direction space of each of the number of measurement beams 404 and a position in the beam direction space of each of a plurality of candidate beams 406, 407 of the second beam pattern, wherein the selected candidate beam 406 is one of the number of candidate beams 406, 407.

By this method, the signal qualities of measurement beams 404, the positions of the measurement beams 404 in the first beam pattern and the positions of the candidate beams 406 of the second beam pattern are taken into account when selecting a candidate beam.

According to an embodiment, the candidate beam 406 is selected 310 based on a weight of the individual measurements of signal quality of each of the number of measurement beams 404.

For example, the measurement beam with the best signal quality has a highest weight, so the candidate beam that is selected in the second beam pattern may be the beam that is closest in the beam direction space to the measurement beam having the best signal quality; or the candidate beam may be the beam that is closest to an average position of the measurement beams, the average position is calculated based on the positions of each of the number of measurement beams. The average position is calculated considering the weight of each measurement beam, the weight is corresponding to the signal quality of each measurement beam. The measurement beam with a better signal quality has a higher weight than the measurement beam with a worse signal quality.

According to another embodiment, the selecting 310 of the candidate beam 406 based on the individual measurements of signal quality of each of the number measurement beams 404, the first beam pattern and the second beam pattern further comprises determine a plurality of candidate beams 406, 407 of the second beam pattern, the determined plurality of candidate beams 406, 407 being beams positioned in the vicinity of the serving beam 402 in the beam direction space. The selecting 310 further comprises selecting the candidate beam 406 among the plurality of candidate beams 406, 407, the selected candidate beam 406 being the one of the plurality of the candidate beams 406, 407 that is closest in the beam direction space to the measurement beam of the number of measurement beams 404 that has the best signal quality, or the one of the plurality of the candidate beams 406, 407 that is closest in the beam direction space to a measurement beam combination of a plurality of the number of measurement beams 404, which combination has the best sum of the signal quality. Being adjacent is an example of being in the vicinity. The meaning of being adjacent has already been defined in the text above.

By such an embodiment, the candidate beam which is nearest to the measurement beam with best signal quality or nearest to the measurement beam combination that has the best sum of signal quality is selected. The embodiment of measurement beam combination will be further explained when describing FIG. 7b in the following text. Thus the signal quality after switching can be guaranteed.

According to another embodiment, the first set of antenna elements and the second set of antenna elements partially but not fully comprise the same antenna elements.

According to another embodiment, the signal quality of each of the number of measurement beams 404 is obtained 308 from measurements performed by the network node 130 on reference signals sent by the UE 140 or from measurement reports received by the network node 130 from the UE 140 of measurements performed by the UE 140 on reference signals sent by the network node 130.

According to another embodiment, the method further comprises switching 314, from the first set of antenna elements to the second set of antenna elements.

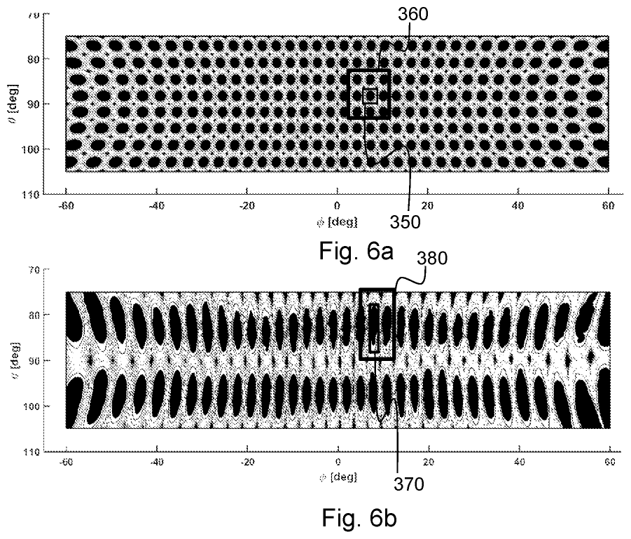

Beamforming in current mmWave products is based on a predefined set of beam weights. FIGS. 6a and 6b shows the beams generated from a typical codebook or look-up-table (LUT). According to this, only a fixed number of beams can be generated, while on the other hand they can easily be indexed. FIG. 6a shows a mapping from a beam generated from a full PAAM panel. FIG. 6b shows a mapping from a beam generated from a smaller part of the PAAM panel. It can be seen that the beam in FIG. 6a is less trivial than the beam in FIG. 6b. The beam in FIG. 6b may cover several beams shown in FIG. 6a. According to an embodiment, the beam pattern shown in FIG. 6a is the first beam pattern and the beam pattern shown in FIG. 6b is the second beam pattern. According to another embodiment, the beam pattern shown in FIG. 6b is the first beam pattern and the beam pattern shown in FIG. 6a is the second beam pattern.

Assuming that a coarse relation between the different beams generated from the codebook or LUT is known to the network node 130. This information could be, for example, that the direction in elevation and azimuth is known by the network node 130. This information can be achieved off-line by measurements in a chamber. A result may look like as in the example of FIGS. 6a and 6b.

During the beam management procedure, the signal qualities of a serving beam and the beams surrounding the severing beams are measured to facilitate beam handovers. Using these measurements together with the knowledge of the beam pointing directions, it is possible to predict the most relevant beam if/when a panel switch occurs. For example, the smaller square 350 in FIG. 6a indicates a serving beam of the whole PAAM which serves a wireless device ‘k’. In this case, all the beams around the serving beam are measured. These beams around the serving beam are measurement beams. The measurement and the serving beam are within the bigger square 360 in FIG. 6a. By the measurements it is possible to judge that the beam indicated by the smaller rectangle 370 in FIG. 6b is the best candidate for serving wireless device ‘k’ when a PAAM-split occurs and hence the broader beam pattern of FIG. 6b is used, The bigger rectangle 380 may symbolize the plurality of candidate beams from which the candidate beam in the smaller rectangle 370 is selected, according to an embodiment.

FIG. 7a shows a schematic diagram of the selection of the candidate beam according to an embodiment in which a PAAM configuration switch is done switching from a smaller amount of antennas to a larger amount of antennas. This can be similar to switching from the second beam pattern in FIG. 6b to the first beam pattern in FIG. 6a. The long ovals indicate the first beam pattern and the rounds indicate the second beam pattern. In this embodiment, the first beam pattern and the second beam pattern are horizontally and vertically aligned. The black oval 402 is the serving beam among the first beam pattern. A number of measurement beams 404 which are neighbours to the serving beam 402 are selected. In this embodiment, two measurement beams 404 are selected, which are indicated by ovals with slanting lines. The signal quality of the measurement beams 404 are obtained, and a plurality of candidate beams 406, 407 are selected. The candidate beams 406 belong to the second beam pattern and are indicated by dotted rounds. One candidate beam among the candidate beams 406, 407 can be selected. In some embodiments, the selected candidate beam 406 can be the nearest candidate beam to the measurement beam which has the best signal quality. For example, if the upper measurement beam 404 has the best signal quality, the upper candidate beam 406 will be selected and used after switching. If the lower measurement beam 404 has the best signal quality, the lower candidate beam 407 will be selected and used.

FIG. 7b shows another schematic diagram of the selection of the candidate beam according to another embodiment which a PAAM configuration switch is done switching from a smaller amount of antennas to a larger amount of antennas. Similarly as for FIG. 7a, the long ovals indicate the first beam pattern and the rounds indicate the second beam pattern. In this embodiment, the second beam pattern is horizontally shifted and vertically aligned in relation to the first beam pattern. Here four measurement beams 414 around the serving beam 412 are selected and measured. Also, four candidate beams 416, 417, 418, 419 are selected due to their adjacent positions to the serving beam 412. One of the candidate beams is selected as the candidate beam being used after switching based on the signal qualities of the measurement beams 414. For example, if the upper measurement beam has a better signal quality than the lower measurement beam, and the left measurement beam has a better signal quality than the right measurement beam, the candidate beam 416 on the upper left corner will be selected. If the upper measurement beam has a better signal quality than the lower measurement beam, and the right measurement beam has a better signal quality than the left measurement beam, the candidate beam 417 on the upper right corner will be selected. In other words, a sum of signal quality of a combination of the measurement beams will be calculated. A combination of the measurement beams here comprises two measurement beams but the combination may comprise more than two measurement beams. The combination of measurement beams that has the best sum of signal quality is chosen, and the candidate beam is closest to the chosen combination of measurement beams.

FIGS. 7c and 7d show other schematic diagrams of the selection of the candidate beam. The long ovals indicate the first beam pattern and the rounds indicate the second beam pattern. In FIG. 7c, the second beam pattern are horizontally aligned and vertically shifted in relation to the first beam pattern. In FIG. 7d, the second beam pattern are horizontally and vertically shifted in relation to the first beam pattern. Similar methods are performed in these scenarios and one candidate beam e.g., 426 or 436, will be selected among the candidate beams.

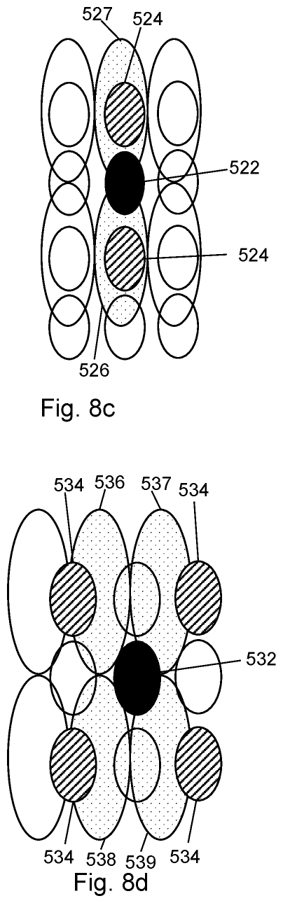

FIG. 8a shows a schematic diagram of the selection of the candidate beam. In this embodiment, a PAAM configuration switch is done switching from a larger amount of antennas to a smaller amount of antennas. The rounds indicate the first beam pattern and the long ovals indicate the second beam pattern. In this embodiment, the first beam pattern and the second beam pattern are horizontally and vertically aligned. The black round 502 is the serving beam of the first beam pattern. Two measurement beams 504 which are neighbours to the serving beam 502 are selected, which are indicated by two rounds with slanting lines. The signal quality of the measurement beams 504 is obtained, and a plurality of candidate beams 506, 507 are selected. The candidate beams 506, 507 belong to the second beam pattern and are indicted by dotted long ovals. One candidate beam among the candidate beams 506, 507 can be selected. For example, if the signal quality of the upper measurement beam 504 is better, the candidate beam 507 is selected. If the signal quality of the lower measurement beam 504 is better, the candidate beam 506 is selected.

FIG. 8b shows another schematic diagram of the selection of the candidate beam. Similarly, the rounds indicate the first beam pattern and the long ovals indicate the second beam pattern. In this embodiment, the second beam pattern is horizontally shifted and vertically aligned in relation to the first beam pattern. The two measurement beams 514 around the serving beam 512 are selected and measured. Two candidate beams 516 and 517 are selected due to their adjacent positions to the serving beam 512. One of the candidate beams is selected as the candidate beam being used after switching based on the signal qualities of the measurement beams 514. For example, if the left measurement beam has a better signal quality than the right measurement beam, the candidate beam 516 on the left will be selected. If the right measurement beam has a better signal quality than the left measurement beam, the candidate beam 517 on the right will be selected.

FIGS. 8c and 8d show other schematic diagrams of the selection of the candidate beam. The rounds indicate the first beam pattern and long ovals indicate the second beam pattern. In FIG. 8c, the second beam pattern is horizontally aligned and vertically shifted in relation to the first beam pattern. In FIG. 8d, the second beam pattern is horizontally and vertically shifted in relation to the first beam pattern. Similar methods are performed in these scenarios and one candidate beam e.g., 526 or 536, will be selected among the candidate beams.

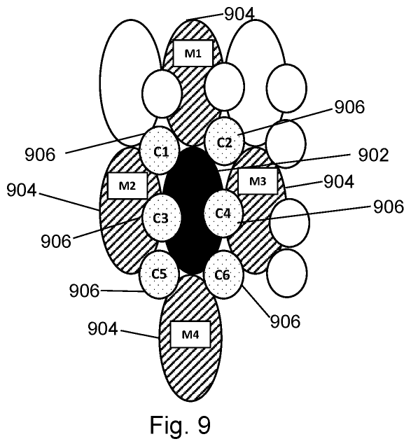

FIG. 9 shows another schematic diagram for the selection of the candidate beam according to an embodiment. The long ovals indicate the first beam pattern and the rounds indicate the second beam pattern. A number of measurement beams 904 are selected due to their adjacent positions to the serving beam 902. The measurement beams 904 include M1, M2, M3 and M4. The signal qualities of M1-M4 are obtained. A plurality of candidate beams 906 are selected which are adjacent to the serving beam 902. The candidate beams 906 are named as C1-C6. One candidate beam will be selected among C1-C6, considering the signal quality of M1-M4. For example, the signal quality of M2 is obviously better than the signal quality of M3, e.g., RSRP of M2 minus RSRP of M3 exceeds a threshold. The phrase “obviously better” has similar meaning in the following text. In this situation, if the signal quality of M1 is obviously better than the signal quality of M4, then the candidate beam C1 which is between the M2 and M1 is selected. If on the other hand, the M1 signal quality has no big difference to the M4 signal quality, e.g., the difference between M1 RSRP and M4 RSRP is lower than a threshold, the candidate beam C3 is selected. The phrase “no big difference” has similar meaning in the following text. If the M4 signal quality is obviously better than the M1 signal quality, C5 is selected. Another possible situation is that M3 signal quality is obviously better than M2 signal quality. Under this situation, if M1 signal quality is obviously better than M4 signal quality, the candidate beam C2 is selected. If M1 signal quality has no big difference to M4 signal quality, C4 is selected. If M4 signal quality is obviously better than M1 signal quality, C6 is selected.

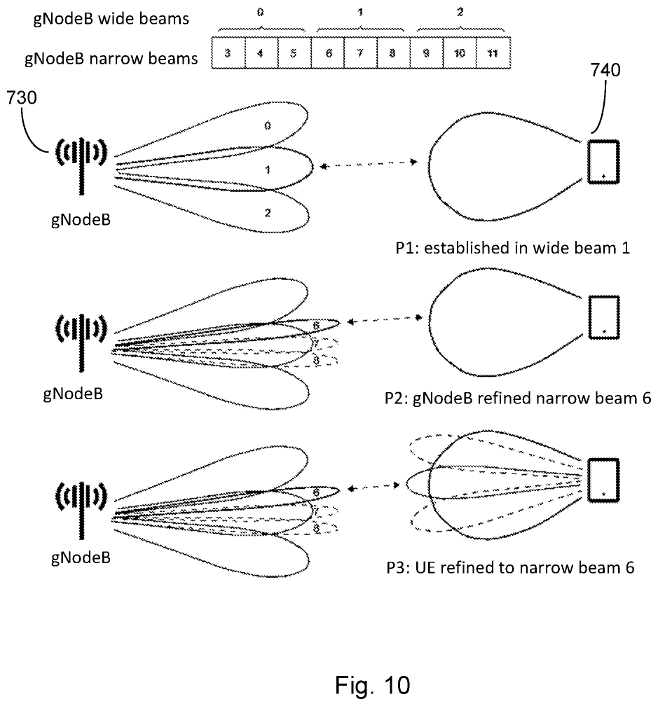

FIG. 10 shows a beam establishment, refinement and tracking procedure between gNodeB 730 and UE 740 according to an embodiment. Once the UE 740 gets into connected state with the gNodeB 730, at least one beam is properly in connection between the UE 740 and the gNodeB 730. The gNodeB 730 will trigger beam refinement and tracking procedure to keep monitoring which is the best beam to be used for transmission and reception between the gNodeB 730 and the UE. As FIG. 10 shows, the gNodeB 730 establishes P1 a connection with the UE first via a wide beam 1 out of three wide beams 0, 1, 2. Then the gNodeB 730 refines P2 the wide beam 1 into narrow beam 6. Accordingly, in case the UE 740 is also equipped with multiple antennas and can provide beam management, the UE 740 also refines its wide beam in P1 and P2 to a narrow beam that corresponds to the narrow beam 6 selected by the gNodeB 730.

CSI resources and CSI reports are scheduled by gNodeB 730 for measurement beams, in order to get corresponding channel information to decide the most suitable traffic beam among all the candidate beams. CSI-RS is beamformed and swept sequentially over every measurement beam. In the dynamic PAAM switching scenario being discussed in this disclosure, the measurement beams and the candidate beams are different beam sets with different beam width and direction, due to different panel/sub-panel sizes before and after switch.

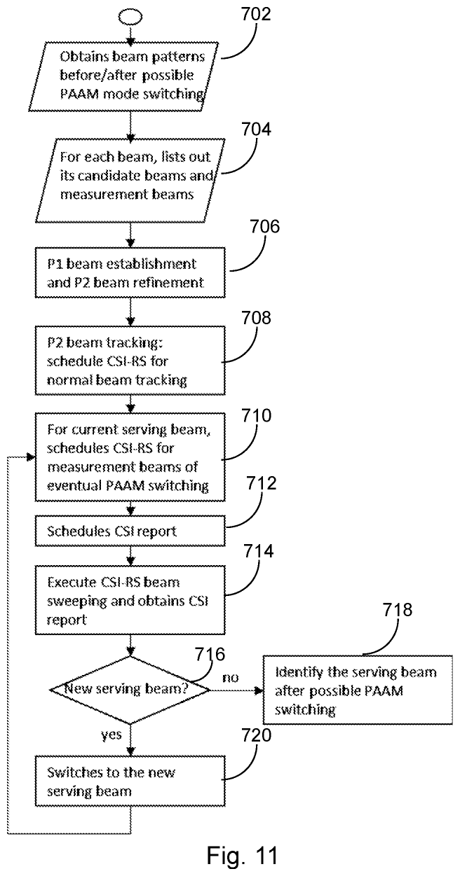

In the following, an embodiment of a procedure is described with reference to FIG. 11, for a UE and a gNodeB such as the ones shown in FIG. 10. The gNodeB 730 obtains beam patterns formed by the panel or sub-panels before and after PAAM switching in step 702. This information can be obtained for example offline by measurements in a chamber, as well by measurements in the field.

Based on the obtained beam pattern information, the gNodeB 730 identifies for each beam its surrounding measurement beams and its candidate beams after any possible PAAM switching in step 704, as discussed in previous embodiments.

In step 706, the gNodeB 730 performs P1 beam establishment and P2 beam refinement shown in FIG. 10. The gNodeB 730 configures beam management procedures, similarly as in legacy, including scheduling of CSI resources and CSI report. Here, CSI resources and CSI report are used as signal qualities of the selected measurement beams.

The gNodeB 730 triggers CSI-RS beam tracking in step 708. In step 710, for current serving beam, the gNodeB 730 schedules CSI-RS for measurement beams of possible PAAM switching. In step 712, the gNodeB 730 schedules CSI report. In step 714, the gNodeB 730 identifies the best narrow beam, executes CSI-RS beam sweeping and obtains CSI report. In step 716, if it is determined that the best narrow beam is the current serving beam of a specific UE 740, the gNodeB 730 continues to identify the best beam to be used after possible PAAM switching in step 718, based on the signal quality measurements of the measurement beams.

In step 716, if it is determined that the new best narrow beam is not the current serving beam, that is a new serving beam, the serving beam is switched to the new best narrow beam in step 720. After that, the gNodeB 730 identifies the new set of measurement beams and candidate beams for the new serving beam, schedules CSI resources and CSI report accordingly, and identifies the best candidate beam to be used after possible PAAM switching.

According to another embodiment, a network node 130 is provided. The network node 130 is configured to operate in a wireless communication network 100 and configured for controlling a Phased Array Antenna Module, PAAM 202, whereby the network node 130 is capable of forming beams for directed communication of wireless signals with a number of user equipment, UE 140, 145. The network node 130 comprises a processing circuitry 603 and a memory 604, said memory 604 containing instructions executable by said processing circuitry 603. The network node 130 is operative for communicating signals with a UE 140 over a serving beam 402 formed by a first set of antenna elements of the PAAM 202, the first set of antenna elements forming a first beam pattern in a beam direction space, the serving beam being one beam in the first beam pattern. The network node 130 is further operative for selecting a number of measurement beams 404 in the first beam pattern, the number of measurement beams being neighbours to the serving beam 402 and obtaining a measurement of signal quality in each of the selected number of measurement beams 404. The network node is further operative for selecting a candidate beam 406 based on the individual measurements of signal quality of each of the number of measurement beams 404, the first beam pattern and the second beam pattern, the second beam pattern being formed by a second set of antenna elements of the PAAM 202, the first set of antenna elements differs from the second set of antenna elements, the selected candidate beam 406 being one beam in the second beam pattern. The network node is further operative for communicating signals with the UE 140 or other UE 145 over the selected candidate beam 406 after switching to the second set of antenna elements.

According to another embodiment, the candidate beam 406 is selected based on the individual measurements of signal quality of each of the number of measurement beams 404, a position in the first beam pattern in the beam direction space of each of the number of measurement beams 404 and a position in the beam direction space of each of a plurality of candidate beams 406, 407 of the second beam pattern, wherein the selected candidate beam 406 is one of the plurality of candidate beams 406, 407.

According to another embodiment, the candidate beam 406 is selected further based on a weight of the individual measurements of signal quality of each of the number of measurement beams 404.

According to another embodiment, the selecting of the candidate beam 406 based on the individual measurements of signal quality of each of the number measurement beams 404, the first beam pattern and the second beam pattern further comprises determining a plurality of candidate beams 406, 407 of the second beam pattern, the determined plurality of candidate beams 406, 407 being beams positioned in the vicinity of the serving beam 402, in the beam direction space. It further comprises selecting the candidate beam 406 among the plurality of candidate beams 406, 407, the selected candidate beam 406 being the one of the plurality of candidate beams 406, 407 that is closest in the beam direction space to the measurement beam of the number of measurement beams 404 that has the best signal quality, or the one of the plurality of the candidate beams 406, 407 that is closest in the beam direction space to a measurement beam combination of a plurality of the number of measurement beams 404, which combination has the best sum of the signal quality.

According to another embodiment, the first set of antenna elements and the second set of antenna elements partially but not fully comprise the same antenna elements.

According to another embodiment, the signal quality of each of the number of measurement beams 404 is obtained from measurements performed by the network node 130 on reference signals sent by the UE 140 or from measurement reports received by the network node 130 from the UE 140 of measurements performed by the UE 140 on reference signals sent by the network node 130.

According to another embodiment, the network node is further operative for switching, from the first set of antenna elements to the second set of antenna elements for communication, before communicating signals with the UE 140 or other UE 145 over the selected candidate beam 406.

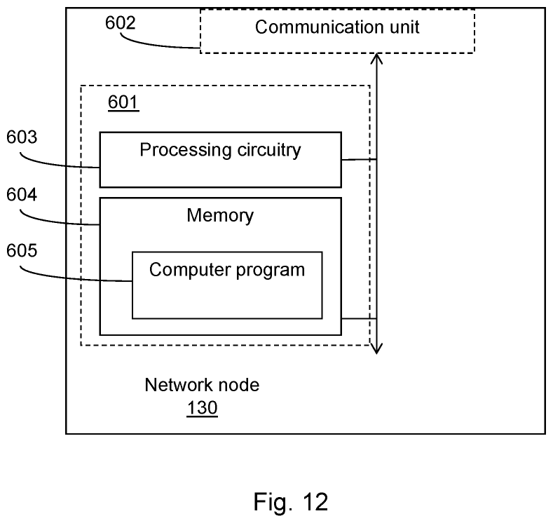

According to other embodiments, referring to FIG. 12, the network node 130 may further comprise a communication unit 602, which may be considered to comprise conventional means for wireless communication with the UE 140, such as a transceiver for wireless transmission and reception of signals. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause network node 130 to perform the steps described in any of the described embodiments of the network node 130 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the network node 130 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1-16. (canceled)

17. A method performed by a network node of a wireless communication network for beam management, the network node controls a Phased Array Antenna Module (PAAM), whereby the network node is capable of forming beams for directed communication of wireless signals with a number of user equipment (UE), the method comprising:
communicating signals with a UE over a serving beam formed by a first set of antenna elements of the PAAM, the first set of antenna elements forming a first beam pattern in a beam direction space, the serving beam being one beam in the first beam pattern;
selecting a number of measurement beams in the first beam pattern, the number of measurement beams being neighbours to the serving beam;
obtaining a measurement of signal quality in each of the selected number of measurement beams;
selecting a candidate beam based on the individual measurements of signal quality of each of the number of measurement beams, the first beam pattern and the second beam pattern, the second beam pattern being formed by a second set of antenna elements of the PAAM, the first set of antenna elements differs from the second set of antenna elements, the selected candidate beam being one beam in the second beam pattern; and
communicating signals with the UE or other UE over the selected candidate beam after switching to the second set of antenna elements.

18. The method as claimed in claim 17, wherein the candidate beam is selected based on the individual measurements of signal quality of each of the number of measurement beams, a position in the first beam pattern in the beam direction space of each of the number of measurement beams, and a position in the beam direction space of each of a plurality of candidate beams of the second beam pattern, wherein the selected candidate beam is one of the plurality of candidate beams.

19. The method as claimed in claim 18, wherein the candidate beam is selected further based on a weight of the individual measurements of signal quality of each of the number of measurement beams.

20. The method as claimed in claim 17, wherein selecting the candidate beam based on the individual measurements of signal quality of each of the number measurement beams, the first beam pattern, and the second beam pattern further comprises:
determining a plurality of candidate beams of the second beam pattern, the determined plurality of candidate beams being beams positioned in the vicinity of the serving beam in the beam direction space; and
selecting the candidate beam from among the plurality of candidate beams, the selected candidate beam being the one of the plurality of candidate beams that is closest in the beam direction space to the measurement beam of the number of measurement beams that has the best signal quality, or the one of the plurality of the candidate beams that is closest in the beam direction space to a measurement beam combination of a plurality of the number of measurement beams, which combination has the best sum of the signal quality.

21. The method as claimed in claim 17, wherein the first set of antenna elements and the second set of antenna elements partially but not fully comprise the same antenna elements.

22. The method as claimed in claim 17, wherein the signal quality of each of the number of measurement beams is obtained from measurements performed by the network node on reference signals sent by the UE or from measurement reports received by the network node from the UE of measurements performed by the UE on reference signals sent by the network node.

23. The method as claimed in claim 17, wherein the method further comprises switching, from the first set of antenna elements to the second set of antenna elements for communication, before communicating signals with the UE or other UE over the selected candidate beam.

24. A network node configured to operate in a wireless communication network and configured for controlling a Phased Array Antenna Module (PAAM), whereby the network node is capable of forming beams for directed communication of wireless signals with a number of user equipment (UE), the network node comprising:
processing circuitry; and
memory comprising instructions executable by the processing circuitry, whereby the network node is configured to:
communicate signals with a UE over a serving beam formed by a first set of antenna elements of the PAAM, the first set of antenna elements forming a first beam pattern in a beam direction space, the serving beam being one beam in the first beam pattern;
select a number of measurement beams in the first beam pattern, the number of measurement beams being neighbours to the serving beam;
obtain a measurement of signal quality in each of the selected number of measurement beams;
select a candidate beam based on the individual measurements of signal quality of each of the number of measurement beams, the first beam pattern and the second beam pattern, the second beam pattern being formed by a second set of antenna elements of the PAAM, the first set of antenna elements differs from the second set of antenna elements, the selected candidate beam being one beam in the second beam pattern; and
communicate signals with the UE or other UE over the selected candidate beam after switching to the second set of antenna elements.

25. The network node as claimed in claim 24, wherein the candidate beam is selected based on the individual measurements of signal quality of each of the number of measurement beams, a position in the first beam pattern in the beam direction space of each of the number of measurement beams, and a position in the beam direction space of each of a plurality of candidate beams of the second beam pattern, wherein the selected candidate beam is one of the plurality of candidate beams.

26. The network node as claimed in claim 25, wherein the candidate beam is selected further based on a weight of the individual measurements of signal quality of each of the number of measurement beams.

27. The network node as claimed in claim 24, wherein the selecting of the candidate beam based on the individual measurements of signal quality of each of the number measurement beams, the first beam pattern, and the second beam pattern further comprises:
determining a plurality of candidate beams of the second beam pattern, the determined plurality of candidate beams being beams positioned in the vicinity of the serving beam in the beam direction space; and
selecting the candidate beam among the plurality of candidate beams, the selected candidate beam being the one of the plurality of candidate beams that is closest in the beam direction space to the measurement beam of the number of measurement beams that has the best signal quality, or the one of the plurality of the candidate beams that is closest in the beam direction space to a measurement beam combination of a plurality of the number of measurement beams, which combination has the best sum of the signal quality.

28. The network node as claimed in claim 24, wherein the first set of antenna elements and the second set of antenna elements partially but not fully comprise the same antenna elements.

29. The network node as claimed in claim 24, wherein the signal quality of each of the number of measurement beams is obtained from measurements performed by the network node on reference signals sent by the UE or from measurement reports received by the network node from the UE of measurements performed by the UE on reference signals sent by the network node.

30. The network node as claimed in claim 24, further configured to switch, from the first set of antenna elements to the second set of antenna elements for communication, before communicating signals with the UE or other UE over the selected candidate beam.

31. A non-transitory computer readable medium comprising computer program instructions stored thereon, which, when executed by processing circuitry of a network node of a wireless communication network configured for controlling a Phased Array Antenna Module (PAAM), the network node comprising multiple antennas, causes the network node to:
communicate signals with a User Equipment (UE) over a serving beam formed by a first set of antenna elements of the PAAM, the first set of antenna elements forming a first beam pattern in a beam direction space, the serving beam being one beam in the first beam pattern,
select a number of measurement beams in the first beam pattern, the number of measurement beams being neighbours to the serving beam;
obtain a measurement of signal quality in each of the selected number of measurement beams;
select a candidate beam based on the individual measurements of signal quality of each of the number of measurement beams, the first beam pattern and the second beam pattern, the second beam pattern being formed by a second set of antenna elements of the PAAM, the first set of antenna elements differs from the second set of antenna elements, the selected candidate beam being one beam in the second beam pattern; and
communicate signals with the UE or other UE over the selected candidate beam after switching to the second set of antenna elements.
